(19) United States
(12) Patent Application Publication
(10) Pub. No.: US 2025/0247762 A1
(43) Pub. Date: Jul. 31, 2025

(54) METHOD AND APPARATUS FOR CELL GROUP CHANGE

(71) Applicant: LENOVO (BEIJING) LIMITED, Beijing (CN)

(72) Inventors: Lianhai Wu, Beijing (CN); Congchi Zhang, Shanghai (CN); Le Yan, Shanghai (CN); Mingzeng Dai, Shanghai (CN); Xiaoying Xu, Shanghai (CN)

(21) Appl. No.: 18/854,653

(22) PCT Filed: May 6, 2022
(86) PCT No.: PCT/CN2022/091098

§ 371 Date: Oct. 7, 2024

(51) Int. Cl. H04W 36/36; H04W 36/00; H04W 76/27

(52) U.S. Cl. CPC H04W 36/362; H04W 76/27; H04W 36/0069

(57) ABSTRACT

Embodiments of the present disclosure relate to methods and apparatuses for cell group (CG) change in a communication system. According to some embodiments of the disclosure, a first BS may: transmit, to a second BS, a first request message, wherein the first request message indicates to prepare an enhanced CPC for a UE and the enhanced CPC is associated with a candidate primary cell of an SCG of a third BS; and receive, from the second BS, a first acknowledge message in response to the first request message.

### TECHNICAL FIELD

Embodiments of the present disclosure generally relate to communication technology, and more particularly to cell group (CG) change in a communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

A UE may receive a radio resource control (RRC) reconfiguration message from a BS. The RRC reconfiguration message may include various configurations for the UE. For example, the RRC reconfiguration message may include conditional reconfiguration information. The UE may perform a corresponding action(s) according to the conditional reconfiguration information.

Solutions for performing cell group (CG) change in a communication system are provided.

### SUMMARY

Some embodiments of the present disclosure provide a first base station (BS). The first BS may include: a transceiver; and a processor coupled to the transceiver. The processor may be configured to: transmit, to a second BS, a first request message, wherein the first request message indicates to prepare an enhanced conditional primary secondary cell (PSCell) change (CPC) for a user equipment (UE) and the enhanced CPC is associated with a candidate primary cell of a secondary cell group (SCG) of a third BS; and receive, from the second BS, a first acknowledge message in response to the first request message. In some embodiments of the present disclosure, the third BS may be the second BS or a BS different from the second BS.

In some embodiments of the present disclosure, the first request message further indicates at least one of the following: a maximum number of enhanced CPCs configurable by the third BS; a first estimated probability of the UE accessing the second BS; a second estimated probability of the UE switching from the second BS to the third BS; or a third estimated probability of the UE accessing the third BS.

In some embodiments of the present disclosure, the enhanced CPC is performed after a conditional PSCell addition (CPA) or a CPC for the UE is performed and an execution condition of the enhanced CPC is met, and the CPA or CPC is associated with a target primary cell of an SCG of the second BS. In some embodiments, the first request message is a request message for the CPA or a request message for the CPC. In some embodiments, the first request message is specific for the enhanced CPC.

In some embodiments of the present disclosure, the processor may be configured to: receive, from the UE, a radio resource control (RRC) reconfiguration complete message indicating that the UE has performed the CPA or CPC; and transmit a message to the third BS in response to receiving the RRC reconfiguration complete message, wherein the message indicates an estimated probability of the UE accessing the third BS.

In some embodiments of the present disclosure, the first acknowledge message includes at least one configuration of the enhanced CPC for the UE and a configuration of a conditional PSCell addition (CPA) for the UE. In some embodiments, the first acknowledge message includes the at least one configuration of the enhanced CPC for the UE and a configuration of a CPC for the UE. In some embodiments, the first acknowledge message includes the at least one configuration of the enhanced CPC for the UE. In some embodiments, each of the at least one configuration of the enhanced CPC includes a CG configuration based on a reference cell. In some embodiments, the reference cell is a cell of the second BS.

In some embodiments of the present disclosure, the processor may be configured to: transmit, to the UE, a first radio resource control (RRC) reconfiguration message, wherein the first RRC reconfiguration message may include an indication indicating that the enhanced CPC is contained in the first RRC reconfiguration message. In some embodiments, the first RRC reconfiguration message includes the configuration of the CPA or the configuration of the CPC and a second RRC reconfiguration message including the at least one configuration of the enhanced CPC.

In some embodiments of the present disclosure, the processor may be configured to: transmit, to the UE, a first radio resource control (RRC) reconfiguration message. In some embodiments, the at least one configuration of the enhanced CPC is included in a conditional reconfiguration information element (IE) in the first RRC reconfiguration message. In some embodiments, the at least one configuration of the enhanced CPC is included in an IE specific for enhanced CPC in the first RRC reconfiguration message. In some embodiments, in the case that the at least one configuration of the enhanced CPC is included in the IE specific for enhanced CPC, an enhanced CPC and a CPC are not configured at the same time.

In some embodiments of the present disclosure, the first acknowledge message may include a message rejecting the preparation of the enhanced CPC from the third BS.

Some embodiments of the present disclosure provide a second base station (BS). The second BS may include: a transceiver; and a processor coupled to the transceiver. The processor may be configured to: receive, from a first BS, a first request message, wherein the first request message indicates to prepare an enhanced conditional primary secondary cell (PSCell) change (CPC) for a user equipment (UE) and the enhanced CPC is associated with a candidate primary cell of a secondary cell group (SCG) of a third BS; and transmit, to the first BS, a first acknowledge message in response to the first request message. In some embodiments of the present disclosure, the third BS may be the second BS or a BS different from the second BS.

In some embodiments of the present disclosure, the enhanced CPC is performed after a conditional PSCell addition (CPA) or a CPC for the UE is performed and an execution condition of the enhanced CPC is met, and the CPA or CPC is associated with a target primary cell of an SCG of the second BS. In some embodiments, the first request message is a request message for the CPA or CPC. In some embodiments, the first request message is specific for the enhanced CPC.

In some embodiments of the present disclosure, the processor may be configured to: transmit a second request message to the third BS to indicate to prepare the enhanced CPC; and receive a second acknowledge message in response to the second request message. The second acknowledge message includes at least one configuration of the enhanced CPC for the UE, wherein each of the at least one configuration of the enhanced CPC comprises a CG configuration based on a reference cell. In some embodiments, the first acknowledge message may include the at least one configuration of the enhanced CPC for the UE. In some embodiments, the reference cell is a cell of the second BS.

In some embodiments of the present disclosure, the processor may be configured to: transmit a second request message to the third BS to indicate to prepare the enhanced CPC; and receive a message rejecting the preparation of the enhanced CPC from the third BS in response to the second request message. In some embodiments, the first acknowledge message may include the message rejecting the preparation of the enhanced CPC.

In some embodiments of the present disclosure, the first request message and the second request message may indicate at least one of the following: a maximum number of enhanced CPCs configurable by the third BS; a first estimated probability of the UE accessing the second BS; a second estimated probability of the UE switching from the second BS to the third BS; or a third estimated probability of the UE accessing the third BS.

Some embodiments of the present disclosure provide a third base station (BS). The third BS may include: a transceiver; and a processor coupled to the transceiver. The processor may be configured to: receive, from a second BS, a second request message, wherein the second request message indicates to prepare an enhanced conditional primary secondary cell (PSCell) change (CPC) for a user equipment (UE) and the enhanced CPC is associated with a candidate primary cell of a secondary cell group (SCG) of the third BS; and transmit, to the second BS, a second acknowledge message or a rejection message in response to the second request message.

In some embodiments of the present disclosure, the enhanced CPC is performed after a conditional PSCell addition (CPA) or a CPC for the UE is performed and an execution condition of the enhanced CPC is met, and the CPA or CPC is associated with a target primary cell of an SCG of the second BS.

In some embodiments of the present disclosure, the second acknowledge message includes at least one configuration of the enhanced CPC for the UE, wherein each of the at least one configuration of the enhanced CPC comprises a CG configuration based on a reference cell. In some embodiments, the reference cell is a cell of the second BS.

In some embodiments of the present disclosure, the second request message indicates at least one of the following: a maximum number of enhanced CPCs configurable by the third BS; a first estimated probability of the UE accessing the second BS; a second estimated probability of the UE switching from the second BS to the third BS; or a third estimated probability of the UE accessing the third BS.

In some embodiments of the present disclosure, the processor may be configured to receive a message indicating an estimated probability of the UE accessing the third BS after the UE has performed the CPA or CPC.

Some embodiments of the present disclosure provide a user equipment (UE). The UE may include: a transceiver; and a processor coupled to the transceiver. The processor may be configured to: receive, from a first base station (BS), a first radio resource control (RRC) reconfiguration message, wherein the first RRC reconfiguration message includes a configuration of an enhanced conditional primary secondary cell (PSCell) change (CPC) for the UE; and transmit, to the first BS, an RRC complete message in response to receiving the first RRC reconfiguration message.

In some embodiments of the present disclosure, the first RRC reconfiguration message comprises an indication indicating that the enhanced CPC is contained in the first RRC reconfiguration message and a second RRC reconfiguration message comprising the configuration of the enhanced CPC.

In some embodiments of the present disclosure, the first RRC reconfiguration message comprises a conditional reconfiguration information element (IE) for CPA or CPC, which comprises the configuration of the enhanced CPC. In some embodiments of the present disclosure, the first RRC reconfiguration message comprises an IE specific for enhanced CPC, which comprises the configuration of the enhanced CPC.

In some embodiments of the present disclosure, the configuration of the enhanced CPC comprises a CG configuration based on a reference cell.

In some embodiments of the present disclosure, the processor may be configured to release the configuration of the enhanced CPC in response to an initiation of a reestablishment procedure or in response to the UE detaching from the first BS.

Some embodiments of the present disclosure provide a method performed by a first base station (BS). The method may include: transmitting, to a second BS, a first request message, wherein the first request message indicates to prepare an enhanced conditional primary secondary cell (PSCell) change (CPC) for a user equipment (UE) and the enhanced CPC is associated with a candidate primary cell of a secondary cell group (SCG) of a third BS; and receiving, from the second BS, a first acknowledge message in response to the first request message.

Some embodiments of the present disclosure provide a method performed by a second base station (BS). The method may include: receiving, from a first BS, a first request message, wherein the first request message indicates to prepare an enhanced conditional primary secondary cell (PSCell) change (CPC) for a user equipment (UE) and the enhanced CPC is associated with a candidate primary cell of a secondary cell group (SCG) of a third BS; and transmitting, to the first BS, a first acknowledge message in response to the first request message.

Some embodiments of the present disclosure provide a method performed by a third base station (BS). The method may include: receiving, from a second BS, a second request message, wherein the second request message indicates to prepare an enhanced conditional primary secondary cell (PSCell) change (CPC) for a user equipment (UE) and the enhanced CPC is associated with a candidate primary cell of a secondary cell group (SCG) of the third BS; and transmitting, to the second BS, a second acknowledge message or a rejection message in response to the second request message.

Some embodiments of the present disclosure provide a method performed by a user equipment (UE). The method may include: receiving, from a first base station (BS), a first radio resource control (RRC) reconfiguration message, wherein the first RRC reconfiguration message includes a configuration of an enhanced conditional primary secondary cell (PSCell) change (CPC) for the UE; and transmitting, to the first BS, an RRC complete message in response to receiving the first RRC reconfiguration message.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a flow chart of an exemplary procedure for secondary node (SN) addition in accordance with some embodiments of the present disclosure;

FIG. 3 illustrates a flow chart of an exemplary procedure of SN change in accordance with some embodiments of the present disclosure;

FIGS. 4-8 illustrate a flow chart of an exemplary procedure of wireless communications in accordance with some embodiments of the present disclosure;

FIGS. 9-12 illustrate a flow chart of an exemplary procedure of UE mobility in accordance with some embodiments of the present disclosure; and

FIG. 13 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

In some embodiments of the present disclosure, a wireless communication system may support a multi-radio dual connectivity (MR-DC) operation. In a MR-DC scenario, a UE may be configured with multiple transceivers and may be configured to utilize resources provided by two different nodes (e.g., two BSs). In some examples, one node may provide new radio (NR) access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, the Xn interface as specified in 3GPP specifications), and at least the MN may be connected to the core network.

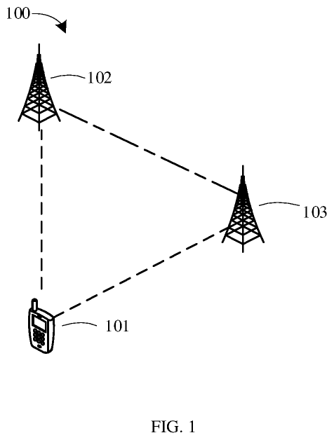

FIG. 1 illustrates a schematic diagram of wireless communication system 100 in accordance with some embodiments of the present disclosure. As shown in FIG. 1, wireless communication system 100 may be a dual connectivity system, and may include at least one UE (e.g., UE 101) and some base stations (e.g., BS 102 acting as a master node (MN), and BS 103 acting as an SN). Although a specific number of UEs and BSs is depicted in FIG. 1, it is contemplated that any number of UEs and BSs (e.g., MNs or SNs) may be included in wireless communication system 100.

Referring to FIG. 1, UE 101 may be connected to BS 102 and BS 103 via a network interface, for example, the Uu interface as specified in 3GPP standard documents. The link established between a UE (e.g., UE 101) and a BS (e.g., BS 102) may be referred to as a Uu link. BS 102 and BS 103 may be connected to each other via a network interface, for example, the Xn interface as specified in 3GPP standard documents. In some examples, BS 102 may be connected to the core network via a network interface (not shown in FIG. 1). UE 102 may be configured to utilize resources provided by BS 102 and BS 103 to perform transmissions.

In some embodiments of the present disclosure, BS 102 may refer to a radio access node that provides a control plane connection to the core network. In some embodiments, in the E-UTRA-NR dual connectivity (EN-DC) scenario, BS 102 may be an eNB. In some embodiments, in the next generation (NG) E-UTRA-NR dual connectivity (NGEN-DC) scenario, BS 102 may be an ng-eNB. In some embodiments, in the NR-E-UTRA dual connectivity (NE-DC) scenario or the NR-NR dual connectivity (NR-DC) scenario, BS 102 may be a gNB.

BS 102 (e.g., MN) may be associated with a master cell group (MCG). The MCG may refer to a group of serving cells associated with BS 102, and may include a primary cell (PCell) and optionally one or more secondary cells (SCells) of the MCG. The PCell may provide a control plane connection to UE 101.

In some embodiments of the present disclosure, BS 103 may refer to a radio access node without a control plane connection to the core network, but providing additional resources to UE 101. In some embodiments, in the EN-DC scenario, BS 103 may be an en-gNB. In some embodiments, in the NE-DC scenario, BS 103 may be an ng-eNB. In some embodiments, in the NR-DC scenario or the NGEN-DC scenario, BS 103 may be a gNB.

BS 103 (e.g., SN) may be associated with a secondary cell group (SCG). The SCG may refer to a group of serving cells associated with BS 103, and may include a primary secondary cell (PSCell) and optionally one or more secondary cells (SCells). For example, the SCG may be a subset of serving cells of BS 103. The PCell of the MCG and the PSCell of the SCG may also be referred to as a special cell (SpCell).

In some embodiments of the present disclosure, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some embodiments of the present disclosure, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network. In some embodiments of the present disclosure, UE 101 may include wearable devices, such as smart watches, fitness bands, optical head-mounted displays, or the like. In some embodiments of the present disclosure, UE 101 may include, for example, but is not limited to, an internet of things (IoT) device or a vehicle. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. Persons skilled in the art should understand that as technology develops and advances, the terminologies described in the present disclosure may change, but should not affect or limit the principles and spirit of the present disclosure.

In some embodiments, a BS (functioning as an MN) may initiate an SN addition procedure to establish a UE context at an SN, so as to provide resources from the SN to a UE served by the MN. In some embodiments, for bearers requiring SCG radio resources, an SN addition procedure may be used to add at least an initial SCG serving cell of the SCG. In some embodiments, an SN addition procedure may also be used to configure an SN terminated MCG bearer (e.g., where no SCG configuration is needed).

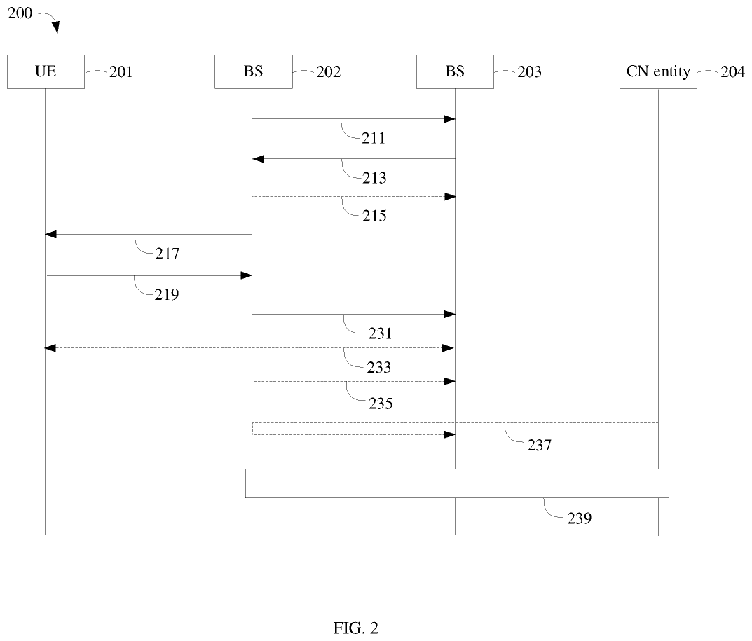

FIG. 2 illustrates a flow chart of exemplary procedure 200 for secondary node (SN) addition in accordance with some embodiments of the present disclosure. Details described in all of the foregoing embodiments of the present disclosure are applicable for the embodiments shown in FIG. 2.

In FIG. 2, UE 201, BS 202, BS 203 may function as UE 101, BS 102, and BS 103 shown in FIG. 1, respectively. At the beginning, UE 201 may be connected to BS 202. BS 202 (i.e., functioning as an MN) may initiate an SN addition procedure to establish a UE context at BS 203 (e.g., functioning as an SN).

For example, BS 202 may decide to request a target SN (e.g., BS 203) to allocate resources for one or more specific protocol data unit (PDR) sessions/quality of service (QOS) flows, indicating QoS Flows characteristics (e.g., QoS flow level QoS parameters, PDU session level transport network layer (TNL) address information, and PDU session level network slice information). Thus, in operation 211, BS 202 may transmit an SN addition request message to BS 203 (e.g., SN). For bearers requiring SCG radio resources, BS 202 may further indicate the requested SCG configuration information, including, for example, the entire UE capabilities and the UE capability coordination results. In this case, BS 202 may also provide the latest measurement results for BS 203 to choose and configure the SCG cell(s). BS 202 may request BS 203 to allocate radio resources for a split signaling radio bearer (SRB) operation. In some embodiments, in the NGEN-DC and NR-DC scenarios, BS 202 may always provide all the needed security information to BS 203 (even if no SN terminated bearers are set up) to enable SRB3 to be set up based on the SN decision.

In response to the SN addition request message, BS 203 may transmit an SN addition request acknowledgement message to BS 202 in operation 213. For example, if the radio resource management (RRM) entity in BS 203 is able to admit the resource request, it allocates respective radio resources and, dependent on the bearer type options, respective transport network resources. For bearers requiring SCG radio resources, BS 203 may trigger a UE random access so that synchronization of the SN radio resource configuration can be performed. BS 203 may decide for the PSCell and other SCells for the SCG, and provide the new SCG radio resource configuration to BS 202 within an SCG RRC configuration message contained in the SN addition request acknowledgement message. If SCG radio resources have been requested, the SCG radio resource configuration may be provided.

In some examples, for SN terminated bearers using MCG resources, BS 203 may provide Xn-U DL TNL address information via an Xn-U address indication message in operation 215 (denoted by a dotted arrow as an option).

In response to receiving the SN addition request acknowledgement message, BS 202 may transmit an RRC reconfiguration message (e.g., MN RRC reconfiguration message) to UE 201 in operation 217. The RRC reconfiguration message may include the SCG RRC configuration message, without modification.

UE 201 may apply the new configuration and reply to BS 202 with an RRC reconfiguration complete message (e.g., MN RRC reconfiguration complete message) in operation 219. The RC reconfiguration complete message may include an SN RRC response message for BS 203 (SN), if needed. In some examples, in the case that UE 201 is unable to comply with (all or part of) the configuration included in the RRC reconfiguration message (e.g., MN RRC reconfiguration message), UE 201 may perform the reconfiguration failure procedure.

In response to receiving the RRC reconfiguration complete message, BS 202 may inform BS 203 (SN) that the UE has completed the reconfiguration procedure successfully via an SN reconfiguration complete message in operation 231. The SN reconfiguration complete message may include the SN RRC response message, if received from UE 201.

In some embodiments, if configured with bearers requiring SCG radio resources, UE 201 may perform synchronization towards the PSCell configured by BS 203 (SN). For example, UE 201 may perform a random access procedure with the configured PSCell in operation 233 (denoted by a dotted arrow as an option). It should be appreciated that the present disclosure does not limit the order a UE 201 transmits the MN RRC reconfiguration complete message and performs the random access procedure towards the SCG. The successful random access procedure towards the SCG is not required for a successful completion of the RRC connection reconfiguration procedure.

In some embodiments, if packet data convergence protocol (PDCP) termination point is changed to the SN for bearers using radio link control (RLC) acknowledge mode (AM), and when RRC full configuration is not used, BS 202 (MN) may transmit the SN status transfer to BS 203 (SN) in operation 235 (denoted by a dotted arrow as an option). In some embodiments, for SN terminated bearers or QoS flows moved from the MN, dependent on the characteristics of the respective bearer or QoS flow, BS 202 (MN) may take actions to minimize service interruption due to the activation of MR-DC. For example, data forwarding may be performed in operation 237 (denoted by a dotted arrow as an option). For instance, data from CN entity 204 (e.g., user plane function (UPF)) may be forwarded to BS 203 (SN) via BS 202 (MN). In some embodiments, if applicable, the update of the user plane (UP) path towards the 5G core (5GC) may be performed via a PDU session path update procedure in operation 239.

It should be appreciated by persons skilled in the art that the sequence of the operations in exemplary procedure 200 may be changed and some of the operations in exemplary procedure 200 may be eliminated or modified, without departing from the spirit and scope of the disclosure.

In some embodiments, an SN change procedure may be performed to, for example, transfer a UE context from a source SN to a target SN and change the SCG configuration in a UE from one SN to another. The SN change procedure may always involve signaling over an MCG SRB towards the UE. The SN change procedure may be initiated by an MN or an SN (source SN).

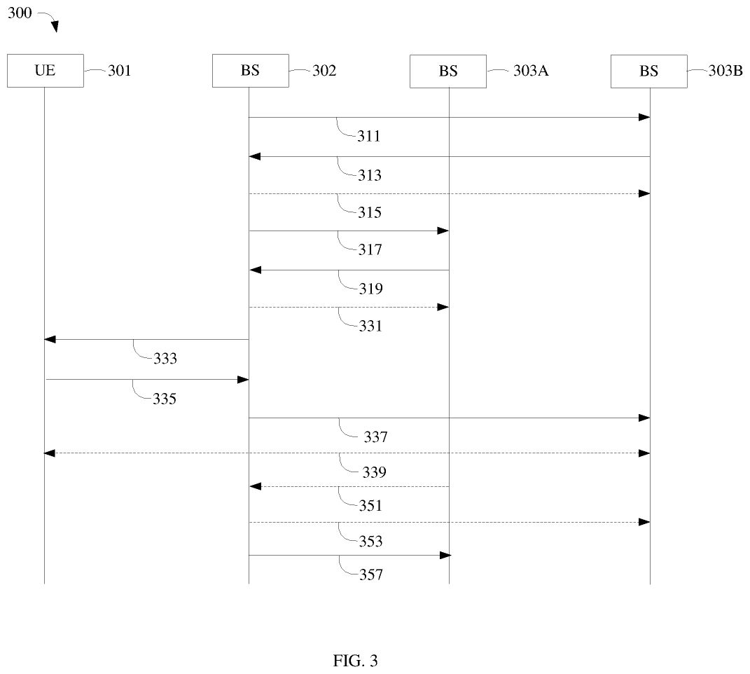

FIG. 3 illustrates a flow chart of exemplary procedure 300 for SN change initiated by an MN in accordance with some embodiments of the present disclosure. Details described in all of the foregoing embodiments of the present disclosure are applicable for the embodiments shown in FIG. 3.

In FIG. 3, UE 301, BS 302, BS 303 may function as UE 101, BS 102, and BS 103 shown in FIG. 1, respectively. At the beginning, UE 301 may be connected to both BS 302 and BS 303A, which respectively functions as an MN and an SN. BS 302 (MN) may initiate the SN change by requesting a target SN (e.g., BS 303B) to allocate resources for UE 301 by means of the SN addition procedure.

For example, in operation 311, BS 302 may transmit an SN addition request message to BS 303B. BS 302 may include measurement results related to BS 303B. In operation 313, BS 303B may transmit an SN addition request acknowledgement message to BS 303B in response to the SN addition request message. If data forwarding is needed, BS 303B may provide data forwarding addresses to BS 302. BS 303B may include the indication of the full or delta RRC configuration.

In some embodiments, BS 302 may trigger an MN-initiated SN modification procedure (to the source SN) to retrieve the current SCG configuration and to allow for the provision of data forwarding related information before operation 311.

In some embodiments, for SN terminated bearers using MCG resources, BS 302 may provide Xn-U DL TNL address information in an Xn-U address indication message in operation 315 (denoted by a dotted arrow as an option).

In some embodiments, descriptions with respect to operations 211-215 in FIG. 2 may be similarly applied to operations 311-315 in FIG. 3.

If the allocation of target SN resources was successful, BS 302 may initiate the release of the source SN resources. For example, in operation 317 (denoted by a dotted arrow as an option), BS 302 may transmit an SN release request message to BS 303A (source SN). The SN release request may include a cause indicating SCG mobility. In operation 319 (denoted by a dotted arrow as an option), BS 303A may transmit an SN release request acknowledgement message to BS 303A (source SN) as a response. In some cases, BS 303A may reject the release.

In some embodiments, if data forwarding is needed, BS 302 may provide data forwarding addresses to BS 303A (source SN) in operation 331 (denoted by a dotted arrow as an option). If direct data forwarding is used for SN terminated bearers, BS 302 may provide data forwarding addresses as received from BS 303B (target SN) to BS 303A (source SN). In some embodiments, reception of the SN release request message may trigger BS 303A to stop providing user data to UE 301.

BS 302 may trigger UE 301 to apply the new configuration. For example, in operation 333, BS 302 may indicate the new configuration to UE 301 in, for example, an MN RRC reconfiguration message including the target SN RRC reconfiguration message. UE 301 may apply the new configuration and transmit, in operation 335, an MN RRC reconfiguration complete message, including an SN RRC response message for BS 303B, if needed. In the case that UE 301 is unable to comply with (all or part of) the configuration included in the MN RRC reconfiguration message, UE 301 may perform the reconfiguration failure procedure.

If the RRC connection reconfiguration procedure was successful, BS 302 may, in operation 337, inform BS 303B via an SN reconfiguration complete message with the included SN RRC response message for BS 303B, if received from UE 301.

In some embodiments, if configured with bearers requiring SCG radio resources, UE 301 may synchronize with BS 303B. For example, in operation 339 (denoted by a dotted arrow as an option), UE 301 may perform a random access procedure with BS 303B.

In some embodiments, if a PDCP termination point is changed for bearers using RLC AM, BS 303A may, in operation 351 (denoted by a dotted arrow as an option), transmit an SN status transfer to BS 302, and BS 302 may, in operation 353 (denoted by a dotted arrow as an option), transmit the received SN status transfer to BS 303B, if needed.

In some embodiments, if applicable, data forwarding from BS 303A (source SN) may take place (not shown in FIG. 3). It may be initiated as early as BS 303A receives the SN Release Request message from BS 302.

In some embodiments, BS 303A (source SN) may transmit a secondary radio access technology (RAT) data usage report message to BS 302 and include the data volumes delivered to and received from UE 301.

In some embodiments, if applicable, BS 302 may trigger a PDU session path update procedure.

In operation 357, in response to receiving the UE context release message, BS 303A (source SN) may release radio and C-plane related resources associated with the UE context. Any ongoing data forwarding may continue.

It should be appreciated by persons skilled in the art that the sequence of the operations in exemplary procedure 300 may be changed and some of the operations in exemplary procedure 300 may be eliminated or modified, without departing from the spirit and scope of the disclosure.

A conditional PSCell Addition (CPA) is defined as a PSCell addition executed by a UE when an execution condition(s) is met. The UE may start evaluating the execution condition(s) in response to receiving the CPA configuration, and stop evaluating the execution condition(s) when the PSCell addition is triggered. A CPA configuration may include the configuration of a CPA candidate PSCell(s) and an execution condition(s) generated by an MN.

A conditional PSCell change (CPC) is defined as a PSCell change executed by a UE when an execution condition(s) is met. The UE may start evaluating the execution condition(s) in response to receiving the CPC configuration, and stop evaluating the execution condition(s) when the PSCell change is triggered. A CPC configuration may include the configuration of a CPC candidate PSCell(s) and an execution condition(s) generated by an SN or an MN (e.g., the one configures the CPC for the UE).

In some embodiments, an execution condition may include one or two trigger condition(s) (e.g., CPC events A3/A5, as defined in 3GPP specifications). In some embodiments, only a single reference single (RS) type may be supported and at most two different trigger quantities (e.g., RSRP and RSRQ, RSRP and SINR, etc.) can be configured simultaneously for the evaluation of the CPC execution condition of a single candidate PSCell.

In some cases, the procedure for the CPC may also be referred to as an SN change.

In some embodiments, a CPA or a CPC may be embedded with a CPC. Such embedded CPC may also be referred to as an enhanced CPA or CPC. For example, when a UE is configured with a CPA or CPC (also referred to as normal CPA or CPC) and an enhanced CPC, the UE may perform the CPA or CPC when the corresponding execution condition for the CPA or CPC is satisfied. The UE may perform the enhanced CPC after the CPA or CPC is performed when the execution condition for the enhanced CPC is satisfied. In this way, a subsequent cell group change (e.g., via the enhanced CPC) after changing the CG (e.g., via the normal CPA or CPC) without reconfiguration and re-initiation of the CPC or CPA is achieved.

For example, as will be described in the following text, in some embodiments, a CPA or a CPC configuration may indicate a target SCG (e.g., a target primary cell of the SCG) and an enhanced CPC associated with a candidate SCG (e.g., a candidate primary cell of the SCG). In some embodiments, the configuration of the enhanced CPC may be configured separately with the CPA or CPC configuration. A UE may access (in the case of a CPA) or switch to (in the case of a CPC) the target primary cell of the SCG (denoted as cell #1C) when the corresponding execution condition for the CPA or CPC is met and may perform the enhanced CPC (e.g., switch from cell #1C to the candidate primary cell of the candidate SCG) after the UE performs the CPA or CPC and the execution condition of the enhanced CPC is met.

Embodiments of the present disclosure provide various solutions to allow a subsequent cell group change after changing a CG without reconfiguration and re-initiation of a CPC or CPA. For example, solutions for configuring an enhanced CPC are proposed. Various issues that may occur during the configuration or after the configuration are studied and corresponding solutions are provided. More details on the embodiments of the present disclosure will be illustrated in the following text in combination with the appended drawings.

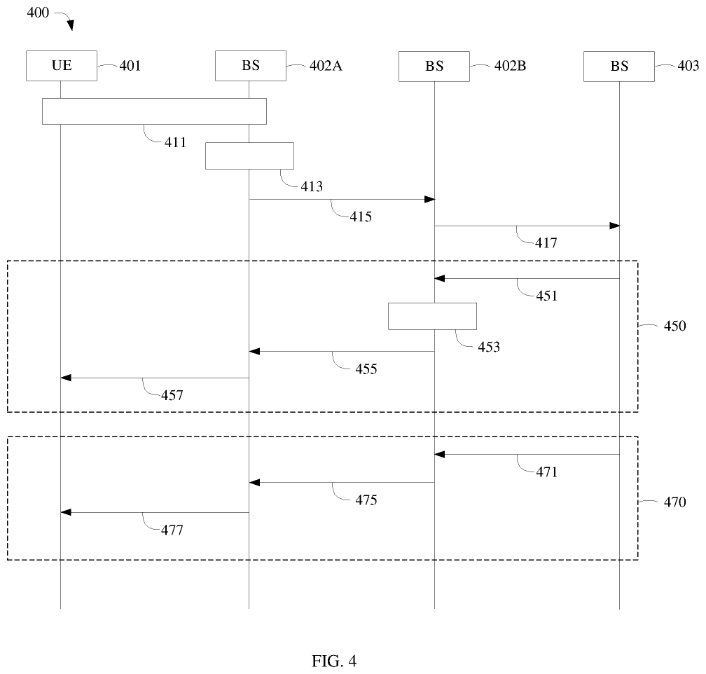

FIG. 4 illustrates a flow chart of exemplary procedure 400 for wireless communications in accordance with some embodiments of the present disclosure. Details described in all of the foregoing embodiments of the present disclosure are applicable for the embodiments shown in FIG. 4.

Referring to FIG. 4, in operation 411, UE 401 may be in a connected state (e.g., RRC_CONNECTED state as specified in 3GPP specifications) and may access its serving cell (e.g., BS 402A). In some embodiments, UE 401 may transmit measurement reports to the serving cell (e.g., BS 402A).

In operation 413, BS 402A (source BS) may determine to configure a CPA and an enhanced CPC for UE 401. For example, UE 401 may be connected to a single serving BS (e.g., BS 402A), which may act as an MN and request another BS (e.g., BS 402B) to configure a CPA for UE 401.

For example, in operation 415, BS 402A may transmit a request message (e.g., an SN addition request message) to BS 402B (target SN) for the CPA. For example, the CPA may be associated with a target primary cell (e.g., PSCell #1) of an SCG of BS 402B. In some embodiments, BS 402A may indicate BS 402B to prepare an enhanced CPC (e.g., PSCell #1->PSCell #2). For example, the request message may indicate (e.g., by including an indicator) to prepare the enhanced CPC for UE 401. The enhanced CPC may be performed after the CPA is performed and an execution condition of the enhanced CPC is met.

In some examples, the request message may indicate the SN (e.g., BS 402B or a BS (e.g., BS 403) different from BS 402B) which configures the enhanced CPC. That is, the enhanced CPC may be associated with a candidate primary cell (e.g., PSCell #2) of an SCG of this SN (denoted as SN #2 for clarity). For example, the request message may indicate that the candidate SCG of the enhanced CPC belongs to BS 402B or BS 403.

In some embodiments, the request message (denoted as request message #1 for clarity) may further indicate at least one of the following: a maximum number of enhanced CPCs configurable by SN #2; an estimated probability (denoted as probability #1) of UE 401 accessing BS 402B; an estimated probability (denoted as probability #2) of UE 401 switching from BS 402B to SN #2; or an estimated probability (denoted as probability #3) of UE 401 accessing SN #2. For example, probability #1 may indicate the probability of UE 401 arriving at BS 402B (e.g., performing the CPA) as “0.6”. For example, probability #2 may indicate the probability of UE 401 switching from BS 402B to SN #2 (e.g., performing the enhanced CPC) as “0.8”. For example, probability #3 may indicate the probability of UE 401 arriving at SN #2 (e.g., performing the CPA and the enhanced CPC) as “0.48”. In some embodiments, probability #3 may be equal to the product of probability #1 and probability #2.

In response to receiving request message #1, BS 402B may prepare a CPA configuration for UE 401, which may indicate a target primary cell of an SCG of BS 402B. In the case that request message #1 indicates that BS 403 (i.e., SN #2) prepares the enhanced CPC. BS 402B may transmit a request message (e.g., an SN addition request message) to BS 403 for the enhanced CPC in operation 417. The request message to BS 403 (denoted as request message #2 for clarity) may indicate (e.g., by including an indicator) to prepare the enhanced CPC. That is, the enhanced CPC may be performed after the CPA is performed and an execution condition of the enhanced CPC is met.

In some embodiments, request message #2 may indicate at least one of: an ID of BS 402A (source MN) or an ID of UE 401. In some examples, the UE ID may be a Source M-NG-RAN node UE XnAP ID. By including the UE ID, a candidate SN (e.g., BS 403) may consider that the SN addition preparation procedures that have been triggered for CPC as part of a normal CPA (or normal CPC). For example, the candidate SN may use the Source M-NG-RAN node ID IE and the UE ID (e.g., Source M-NG-RAN node UE XnAP ID IE) to identify other active SN node addition preparations related to a specific UE (e.g., UE 401) for CPC.

In some embodiments, request message #2 may indicate at least one of the following: a maximum number of enhanced CPCs configurable by BS 403; probability #1; probability #2; or probability #3.

In some embodiments, BS 403 may acknowledge the preparation of the enhanced CPC. An exemplary procedure is shown in procedure 450 in FIG. 4. In some embodiments, BS 403 may reject the preparation of the enhanced CPC. An exemplary procedure is shown in procedure 470 in FIG. 4.

According to procedure 450, in operation 451, BS 403 may transmit an acknowledgement message (e.g., an SN addition request acknowledgement message) to BS 402B in response to receiving request message #2. The acknowledgement message (denoted as acknowledgement message #2 for clarity) may include at least one configuration of the enhanced CPC for UE 401.

In some embodiments, each of the at least one configuration of the enhanced CPC may include a CG configuration based on a reference cell (or a PSCell). In some embodiments, the reference cell may be a cell of BS 402B. The at least one configuration may be delta configuration or full configuration.

For example, a configuration of an enhanced CPC may include a CG configuration for a candidate SCG (e.g., a candidate primary cell of an SCG of BS 403) based on a reference cell. The configuration of the enhanced CPC may also indicate an ID of the reference cell. In the case that a plurality of candidate SCGs is configured, the corresponding CG configurations can be based on the same or different reference cells.

The following pseudo-code shows an exemplary configuration of an enhanced CPC:

| | |
|---|---|
| CG-CandidateInfo-r18 ::= | SEQUENCE { |
| cg-CandidateInfoId-r18 | CG-CandidateInfoId-r18, |
| referencedCellID | Cell identity |
| candidateCG-Config-r18 | OCTET STRING (CONTAINING CG-Config) |
| } | |

In response to receiving acknowledgement message #2, BS 402B may add the execution condition(s) for the enhanced CPC in operation 453. In some examples, for each of the at least one configuration of the enhanced CPC, a corresponding execution condition may be added. BS 402B may transmit acknowledgement message #2 to BS 402A. For example, in operation 455, BS 402B may transmit an acknowledgement message (e.g., an SN addition request acknowledgement message) to BS 402A as a response to request message #1. In some embodiments, the acknowledgement message (denoted as acknowledgement message #1 for clarity) may include the CPA configuration for UE 401 and the at least one configuration of the enhanced CPC.

BS 402A may transmit the CPA configuration and the at least one configuration of the enhanced CPC to UE 401. For example, in operation 457, BS 402A may transmit an RRC reconfiguration message (denoted as message #A for clarity) to UE 401.

In some embodiments, message #A may be an RRC reconfiguration message for CPA and may include the CPA configuration. The at least one configuration of the enhanced CPC may be contained or embedded in message #A. For example, the at least one configuration of the enhanced CPC may be included in an RRC reconfiguration message, which may be encapsulated (e.g., as a container) in message #A. In some embodiments, message #A may include an indication indicating that the enhanced CPC is contained in message #A.

In some embodiments, the configuration of the enhanced CPC may not be encapsulated in message #A. In some examples, the at least one configuration of the enhanced CPC may be included in a conditional reconfiguration information element (IE) in message #A, which may be used to configure a normal CPA or CPC. The CPA configuration may also be included in a conditional reconfiguration IE in message #A. A UE can differentiate the enhanced CPC and a normal CPC based on whether a referenced cell (e.g., PSCell) is configured or not in the corresponding IE. In some examples, the at least one configuration of the enhanced CPC may be included in an IE specific for enhanced CPC in an RRC reconfiguration message (e.g., message #A). Such IE may be different from the conditional reconfiguration IE used to configure a normal CPA or CPC. In the case that the at least one configuration of the enhanced CPC is included in the IE specific for enhanced CPC, an enhanced CPC and a normal CPC cannot be configured at the same time. For example, separate RRC reconfiguration messages may be used to configure a normal CPC and an enhanced CPC, respectively.

In response to receiving the CPA configuration and the at least one configuration of the enhanced CPC (e.g., receiving message #A), UE 401 may evaluate the condition for the CPA according to the CPA configuration. In some embodiments, UE 401 may release the at least one configuration of the enhanced CPC in response to an initiation of a reestablishment procedure at UE 401 or in response to UE 401 detaching from BS 402A (e.g., PCell changes or MN changes).

According to procedure 470, in operation 471, BS 403 may transmit a rejection message (e.g., an SN addition request reject message) to BS 402B in response to receiving request message #2. The rejection message informs BS 402B that the SN addition preparation has failed. In some embodiments, the failure cause may be included in the rejection message.

In operation 475, BS 402B may transmit an acknowledgement message to BS 402A as a response to request message #1. In some embodiments, the acknowledgement message to BS 402A may include the rejection message from BS 403. In some embodiments, the acknowledgement message to BS 402A may include the CPA configuration for UE 401.

BS 402A may transmit the CPA configuration to UE 401. For example, in operation 477, BS 402A may transmit an RRC reconfiguration message including the CPA configuration to UE 401.

In the case that the enhanced CPC involve BS 402B (target SN), the operations described above between BS 402B and BS 403 may be omitted. For example, BS 402B may prepare the configuration of the enhanced CPC. BS 402B may transmit the configuration of the enhanced CPC and the CPA configuration to BS 402A if the SN addition preparation for the enhanced CPC succeeds. BS 402B may transmit the CPA configuration and a rejection message if the SN addition preparation for the enhanced CPC has failed.

It should be appreciated by persons skilled in the art that the sequence of the operations in exemplary procedure 400 may be changed and that some of the operations in exemplary procedure 400 may be eliminated or modified, without departing from the spirit and scope of the disclosure.

FIG. 5 illustrates a flow chart of exemplary procedure 500 for wireless communications in accordance with some embodiments of the present disclosure. Details described in all of the foregoing embodiments of the present disclosure are applicable for the embodiments shown in FIG. 5.

Referring to FIG. 5, in operation 511, UE 501 may be in a connected state (e.g., RRC_CONNECTED state as specified in 3GPP specifications) and may access its serving cell (e.g., BS 502A). In some embodiments, UE 501 may transmit measurement reports to the serving cell (e.g., BS 502A).

In operation 513, BS 502A (source BS) may determine to configure a CPC and an enhanced CPC for UE 501. For example, UE 501 may be connected to two serving BSs, for instance, BS 502A acting as an MN and another BS acting as an SN (hereinafter denoted as SN #OA for clarity). BS 502A may request yet another BS (target SN, such as BS 502B) to configure a CPC for UE 501.

For example, in operation 515, BS 502A may transmit a request message (e.g., an SN addition request message) to BS 502B (target SN) for the CPC (e.g., PSCell #0A of SN #0A->PSCell #1A). For example, the CPC may be associated with a target primary cell (e.g., PSCell #1A) of an SCG of BS 502B. In some embodiments, BS 502A may indicate BS 502B to prepare an enhanced CPC (e.g., PSCell #1A->PSCell #2A). For example, the request message may indicate (e.g., by including an indicator) to prepare the enhanced CPC for UE 501. The enhanced CPC may be performed after the CPC is performed and an execution condition of the enhanced CPC is met.

In some examples, the request message may indicate the SN (e.g., BS 502B or a BS (e.g., BS 503) different from BS 502B) which configures the enhanced CPC. That is, the enhanced CPC may be associated with a candidate primary cell (e.g., PSCell #2A) of an SCG of this SN (denoted as SN #2A for clarity). For example, the request message may indicate that the candidate SCG of the enhanced CPC belongs to BS 502B or BS 503.

In some embodiments, the request message (denoted as request message #1A for clarity) may further indicate at least one of the following: a maximum number of enhanced CPCs configurable by SN #2A; an estimated probability (denoted as probability #1A) of UE 501 accessing BS 502B; an estimated probability (denoted as probability #2A) of UE 501 switching from BS 502B to SN #2A; or an estimated probability (denoted as probability #3A) of UE 501 accessing SN #2A. For example, probability #1A may indicate the probability of UE 501 arriving at BS 502B (e.g., performing the CPC) as “0.6”. For example, probability #2A may indicate the probability of UE 501 switching from BS 502B to SN #2A (e.g., performing the enhanced CPC) as “0.8”. For example, probability #3A may indicate the probability of UE 501 arriving at SN #2A (e.g., performing the CPC and the enhanced CPC) as “0.58”. In some embodiments, probability #3A may be equal to the product of probability #1A and probability #2A.

In response to receiving request message #1A, BS 502B may prepare a CPC configuration for UE 501, which may indicate a target primary cell of an SCG of BS 502B. In the case that request message #1A indicates that BS 503 (i.e., SN #2A) prepares the enhanced CPC, BS 502B may transmit a request message (e.g., an SN addition request message) to BS 503 for the enhanced CPC in operation 517. The request message to BS 503 (denoted as request message #2A for clarity) may indicate (e.g., by including an indicator) to prepare the enhanced CPC. That is, the enhanced CPC may be performed after the CPC is performed and an execution condition of the enhanced CPC is met.

In some embodiments, request message #2A may indicate at least one of: an ID of BS 502A (source MN) or an ID of UE 501. In some examples, the UE ID may be a Source M-NG-RAN node UE XnAP ID. By including the UE ID, a candidate SN (e.g., BS 503) may consider that the SN addition preparation procedures that have been triggered for CPC as part of a normal CPC (or normal CPA). For example, the candidate SN may use the Source M-NG-RAN node ID IE and the UE ID (e.g., Source M-NG-RAN node UE XnAP ID IE) to identify other active SN node addition preparations related to a specific UE (e.g., UE 501) for CPC.

In some embodiments, request message #2A may indicate at least one of the following: a maximum number of enhanced CPCs configurable by BS 503; probability #1A; probability #2A; or probability #3A.

In some embodiments, BS 503 may acknowledge the preparation of the enhanced CPC. An exemplary procedure is shown in procedure 550 in FIG. 5. In some embodiments, BS 503 may reject the preparation of the enhanced CPC. An exemplary procedure is shown in procedure 570 in FIG. 5.

According to procedure 550, in operation 551, BS 503 may transmit an acknowledgement message (e.g., an SN addition request acknowledgement message) to BS 502B in response to receiving request message #2A. The acknowledgement message (denoted as acknowledgement message #2A for clarity) may include at least one configuration of the enhanced CPC for UE 501.

In some embodiments, each of the at least one configuration of the enhanced CPC may include a CG configuration based on a reference cell (or a PSCell). In some embodiments, the reference cell may be a cell of BS 502B. The at least one configuration may be delta configuration or full configuration.

For example, a configuration of an enhanced CPC may include a CG configuration for a candidate SCG (e.g., a candidate primary cell of an SCG of BS 503) based on a reference cell. The configuration of the enhanced CPC may also indicate an ID of the reference cell. In the case that a plurality of candidate SCGs is configured, the corresponding CG configurations can be based on the same or different reference cells.

The following pseudo-code shows an exemplary configuration of an enhanced CPC:

| | |
|---|---|
| CG-CandidateInfo-r18 ::= | SEQUENCE { |
| cg-CandidateInfoId-r18 | CG-CandidateInfoId-r18, |
| referencedCellID | Cell identity |
| candidateCG-Config-r18 | OCTET STRING (CONTAINING CG-Config) |
| } | |

In response to receiving acknowledgement message #2A, BS 502B may add the execution condition(s) for the enhanced CPC in operation 553. In some examples, for each of the at least one configuration of the enhanced CPC, a corresponding execution condition may be added. BS 502B may transmit acknowledgement message #2A to BS 502A. For example, in operation 555, BS 502B may transmit an acknowledgement message (e.g., an SN addition request acknowledgement message) to BS 502A as a response to request message #1A. In some embodiments, the acknowledgement message (denoted as acknowledgement message #1A for clarity) may include the CPC configuration for UE 501 and the at least one configuration of the enhanced CPC.

BS 502A may transmit the CPC configuration and the at least one configuration of the enhanced CPC to UE 501. For example, in operation 557, BS 502A may transmit an RRC reconfiguration message (denoted as message #B for clarity) to UE 501.

In some embodiments, message #B may be an RRC reconfiguration message for CPC and may include the CPC configuration. The at least one configuration of the enhanced CPC may be contained or embedded in message #B. For example, the at least one configuration of the enhanced CPC may be included in an RRC reconfiguration message, which may be encapsulated (e.g., as a container) in message #B. In some embodiments, message #B may include an indication indicating that the enhanced CPC is contained in message #B.

In some embodiments, the configuration of the enhanced CPC may not be encapsulated in message #B.

In some examples, the at least one configuration of the enhanced CPC may be included in a conditional reconfiguration IE in message #B, which may be used to configure a normal CPA or CPC. The CPC configuration may also be included in a conditional reconfiguration IE in message #B. A UE can differentiate the enhanced CPC and the CPC based on whether a referenced cell (e.g., PSCell) is configured or not in the corresponding IE.

In some examples, the at least one configuration of the enhanced CPC may be included in an IE specific for enhanced CPC in an RRC reconfiguration message (e.g., message #B). Such IE may be different from the conditional reconfiguration IE used to configure a normal CPA or CPC. In the case that the at least one configuration of the enhanced CPC is included in the IE specific for enhanced CPC, an enhanced CPC and a normal CPC cannot be configured at the same time. For example, separate RRC reconfiguration messages may be used to configure a normal CPC and an enhanced CPC, respectively. For example, message #B may include the at least one configuration of the enhanced CPC. BS 502A may transmit another RRC reconfiguration message including the CPC configuration to UE 501.

In response to receiving the CPC configuration and the at least one configuration of the enhanced CPC, UE 501 may evaluate the condition for the CPC according to the CPC configuration. In some embodiments, UE 501 may release the at least one configuration of the enhanced CPC in response to an initiation of a reestablishment procedure at UE 501 or in response to UE 501 detaching from BS 502A (e.g., PCell changes or MN changes).

According to procedure 570, in operation 571, BS 503 may transmit a rejection message (e.g., an SN addition request reject message) to BS 502B in response to receiving request message #2A. The rejection message informs BS 502B that the SN addition preparation has failed. In some embodiments, the failure cause may be included in the rejection message.

In operation 575, BS 502B may transmit an acknowledgement message to BS 502A as a response to request message #1A. In some embodiments, the acknowledgement message to BS 502A may include the rejection message from BS 503. In some embodiments, the acknowledgement message to BS 502A may include the CPC configuration for UE 501.

BS 502A may transmit the CPC configuration to UE 501. For example, in operation 577, BS 502A may transmit an RRC reconfiguration message including the CPC configuration to UE 501.

In the case that the enhanced CPC involve BS 502B (target SN), the operations described above between BS 502B and BS 503 may be omitted. For example, BS 502B may prepare the configuration of the enhanced CPC. BS 502B may transmit the configuration of the enhanced CPC and the CPC configuration to BS 502A if the SN addition preparation for the enhanced CPC succeeds. BS 502B may transmit the CPC configuration and a rejection message if the SN addition preparation for the enhanced CPC has failed.

It should be appreciated by persons skilled in the art that the sequence of the operations in exemplary procedure 500 may be changed and that some of the operations in exemplary procedure 500 may be eliminated or modified, without departing from the spirit and scope of the disclosure.

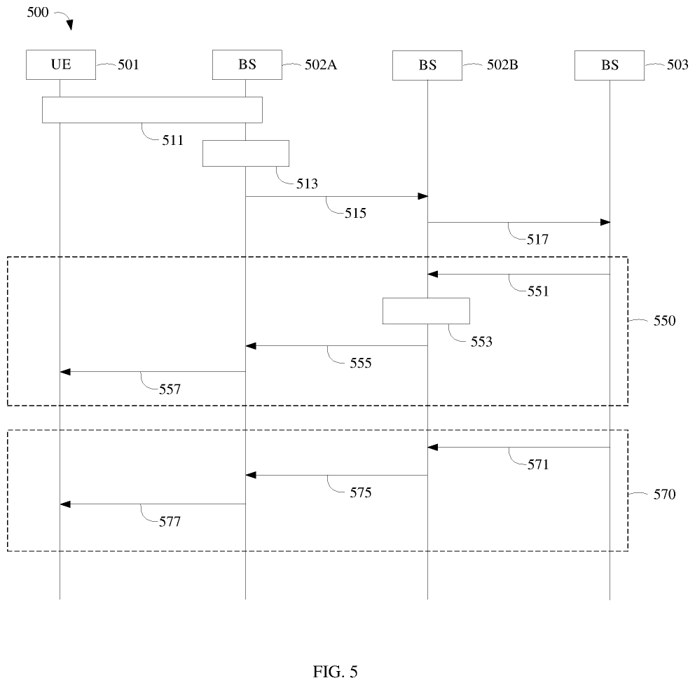

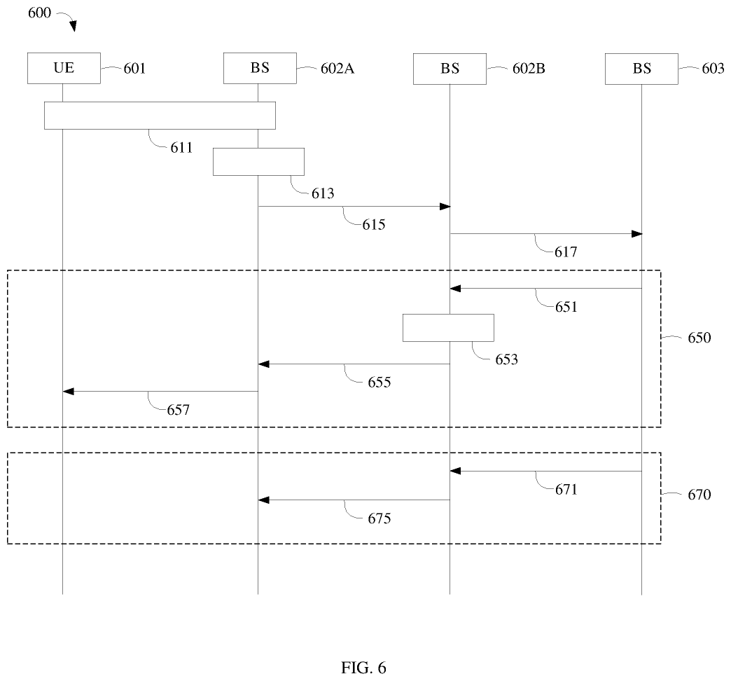

FIG. 6 illustrates a flow chart of exemplary procedure 600 for wireless communications in accordance with some embodiments of the present disclosure. Details described in all of the foregoing embodiments of the present disclosure are applicable for the embodiments shown in FIG. 6.

Referring to FIG. 6, in operation 611, UE 601 may be in a connected state (e.g., RRC_CONNECTED state as specified in 3GPP specifications) and may access its serving cell (e.g., BS 602A). In some embodiments, UE 601 may transmit measurement reports to the serving cell (e.g., BS 602A).

In operation 613, BS 602A (source BS) may determine to configure an enhanced CPC for UE 601. For example, UE 601 may be connected to two serving BSs, for instance, BS 602A acting as an MN and another BS acting as an SN (hereinafter denoted as SN #OB for clarity). BS 602A may have requested yet another BS (target SN, such as BS 602B) to configure a CPC (e.g., PSCell #0B of SN #0B->PSCell #1B) for UE 601. For example, the CPC may be associated with a target primary cell (e.g., PSCell #1B) of an SCG of BS 602B. BS 602A may further request an enhanced CPC associated with the CPC. That is, the enhanced CPC may be performed after the CPC is performed and an execution condition of the enhanced CPC is met.

For example, in operation 615, BS 602A may transmit a request message (e.g., an SN addition request message) to BS 602B (target SN) for an enhanced CPC (e.g., PSCell #1B->PSCell #2B). In some embodiments, BS 602A may indicate BS 602B to prepare a candidate SCG for the enhanced CPC. For example, the request message may indicate (e.g., by including an indicator) to prepare the enhanced CPC for UE 601. The enhanced CPC may be performed after the CPC is performed and an execution condition of the enhanced CPC is met.

In some examples, the request message may indicate the SN (e.g., BS 602B or a BS (e.g., BS 603) different from BS 602B) which configures the enhanced CPC. That is, the enhanced CPC may be associated with a candidate primary cell (e.g., PSCell #2B) of an SCG of this SN (denoted as SN #2B for clarity). For example, the request message may indicate that the candidate SCG of the enhanced CPC belongs to BS 602B or BS 603.

In some embodiments, the request message (denoted as request message #1B for clarity) may further indicate at least one of the following: a maximum number of enhanced CPCs configurable by SN #2B; an estimated probability (denoted as probability #1B) of UE 601 accessing BS 602B; an estimated probability (denoted as probability #2B) of UE 601 switching from BS 602B to SN #2B; or an estimated probability (denoted as probability #3B) of UE 601 accessing SN #2B. For example, probability #1B may indicate the probability of UE 601 arriving at BS 602B (e.g., performing the CPC) as “0.6”. For example, probability #2B may indicate the probability of UE 601 switching from BS 602B to SN #2B (e.g., performing the enhanced CPC) as “0.8”. For example, probability #3B may indicate the probability of UE 601 arriving at SN #2B (e.g., performing the CPC and the enhanced CPC) as “0.68”. In some embodiments, probability #3B may be equal to the product of probability #1B and probability #2B.

In the case that request message #1B indicates that BS 603 (i.e., SN #2B) prepares the enhanced CPC, BS 602B may transmit a request message (e.g., an SN addition request message) to BS 603 for the enhanced CPC in operation 617. The request message to BS 603 (denoted as request message #2B for clarity) may indicate (e.g., by including an indicator) to prepare the enhanced CPC. As stated above, the enhanced CPC may be performed after the associated CPC is performed and an execution condition of the enhanced CPC is met.

In some embodiments, request message #2B may indicate at least one of: an ID of BS 602A (source MN) or an ID of UE 601. In some examples, the UE ID may be a Source M-NG-RAN node UE XnAP ID. By including the UE ID, a candidate SN (e.g., BS 603) may consider that the SN addition preparation procedures that have been triggered for CPC as part of a normal CPC or normal CPA. For example, the candidate SN may use the Source M-NG-RAN node ID IE and the UE ID (e.g., Source M-NG-RAN node UE XnAP ID IE) to identify other active SN node addition preparations related to a specific UE (e.g., UE 601) for CPC.

In some embodiments, request message #2B may indicate at least one of the following: a maximum number of enhanced CPCs configurable by BS 603; probability #1B; probability #2B; or probability #3B.

In some embodiments, BS 603 may acknowledge the preparation of the enhanced CPC. An exemplary procedure is shown in procedure 650 in FIG. 6. In some embodiments, BS 603 may reject the preparation of the enhanced CPC. An exemplary procedure is shown in procedure 670 in FIG. 6.

According to procedure 650, in operation 651, BS 603 may transmit an acknowledgement message (e.g., an SN addition request acknowledgement message) to BS 602B in response to receiving request message #2B. The acknowledgement message (denoted as acknowledgement message #2B for clarity) may include at least one configuration of the enhanced CPC for UE 601.

In some embodiments, each of the at least one configuration of the enhanced CPC may include a CG configuration based on a reference cell (or a PSCell). In some embodiments, the reference cell may be a cell of BS 602B. The at least one configuration may be delta configuration or full configuration.

For example, a configuration of an enhanced CPC may include a CG configuration for a candidate SCG (e.g., a candidate primary cell of an SCG of BS 603) based on a reference cell. The configuration of the enhanced CPC may also indicate an ID of the reference cell. In the case that a plurality of candidate SCGs is configured, the corresponding CG configurations can be based on the same or different reference cells.

In response to receiving acknowledgement message #2B, BS 602B may add the execution condition(s) for the enhanced CPC in operation 653. In some examples, for each of the at least one configuration of the enhanced CPC, a corresponding execution condition may be added. BS 602B may transmit acknowledgement message #2B to BS 602A. For example, in operation 655, BS 602B may transmit an acknowledgement message (e.g., an SN addition request acknowledgement message) to BS 602A as a response to request message #1B. In some embodiments, the acknowledgement message (denoted as acknowledgement message #1B for clarity) may include the at least one configuration of the enhanced CPC.

BS 602A may transmit the at least one configuration of the enhanced CPC to UE 601. For example, in operation 657, BS 602A may transmit an RRC reconfiguration message including the at least one configuration of the enhanced CPC to UE 601.

In some embodiments, UE 601 may release the at least one configuration of the enhanced CPC in response to an initiation of a reestablishment procedure at UE 601 or in response to UE 601 detaching from BS 602A (e.g., PCell changes or MN changes).

According to procedure 670, in operation 671, BS 603 may transmit a rejection message (e.g., an SN addition request reject message) to BS 602B in response to receiving request message #2B. The rejection message informs BS 602B that the SN addition preparation has failed. In some embodiments, the failure cause may be included in the rejection message.

In operation 675, BS 602B may transmit an acknowledgement message to BS 602A as a response to request message #1B. In some embodiments, the acknowledgement message to BS 602A may include the rejection message from BS 603.

In the case that the enhanced CPC involve BS 602B (target SN), the operations described above between BS 602B and BS 603 may be omitted. For example, BS 602B may prepare the configuration of the enhanced CPC. BS 602B may transmit the configuration of the enhanced CPC to BS 602A if the SN addition preparation for the enhanced CPC succeeds. BS 602B may transmit a rejection message if the SN addition preparation for the enhanced CPC has failed.

It should be appreciated by persons skilled in the art that the sequence of the operations in exemplary procedure 600 may be changed and that some of the operations in exemplary procedure 600 may be eliminated or modified, without departing from the spirit and scope of the disclosure.

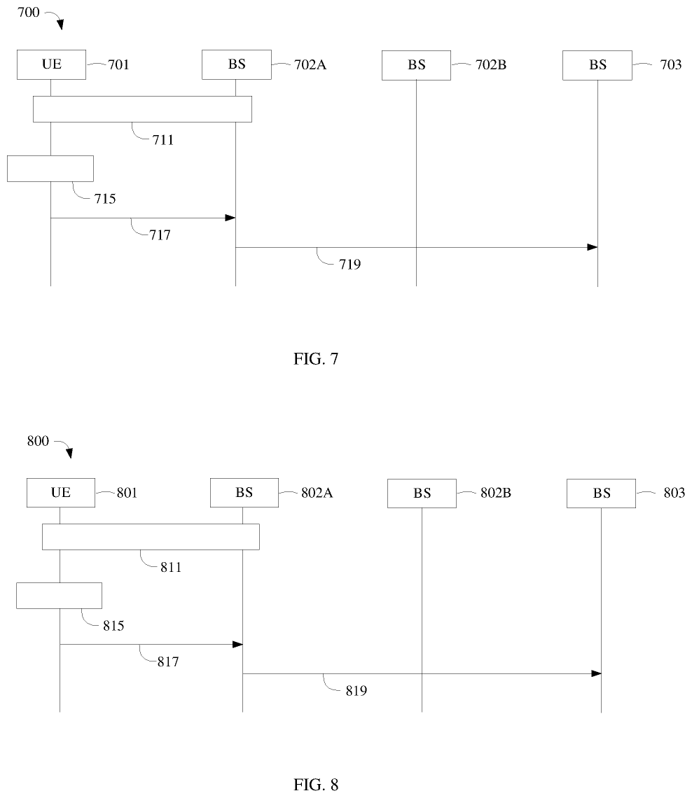

FIG. 7 illustrates a flow chart of exemplary procedure 700 for wireless communications in accordance with some embodiments of the present disclosure. Details described in all of the foregoing embodiments of the present disclosure are applicable for the embodiments shown in FIG. 7.

Referring to FIG. 7, in operation 711, UE 701 may be in a connected state (e.g., RRC_CONNECTED state as specified in 3GPP specifications) and may access its serving cell (e.g., BS 702A). In some embodiments, UE 701 may be configured with a CPA, which may be associated with a target primary cell (e.g., PSCell #1C) of an SCG of BS 702B. In some embodiments, UE 701 may be further configured with an enhanced CPC, which may be associated with a candidate primary cell (e.g., PSCell #2C) of an SCG of BS 703. The enhanced CPC (e.g., PSCell #1C->PSCell #2C) may be performed after the CPA is performed and an execution condition of the enhanced CPC is met. The descriptions regarding the enhanced CPC in the foregoing embodiments may apply here. For example, the configuration of the enhanced CPC may include a CG configuration based on a reference cell.

In operation 715, UE 701 may evaluate the execution condition of the CPA and may perform a CPA procedure when the execution condition is met. In response to successfully performing the CPA procedure, UE 701 may transmit an RRC reconfiguration complete message to the network (e.g., the source MN BS 702A or the target SN BS 702B). For example, in operation 717, UE 701 may transmit an RRC reconfiguration complete message indicating that UE 701 has performed the CPA to BS 702A.

In response to receiving the RRC reconfiguration complete message, BS 702A may, in operation 719, transmit a message to BS 703 (to which the candidate primary cell of the enhanced CPC belongs). The message may indicate that UE 701 has accesses the target primary cell (e.g., PSCell #1C) of the CPA. In some embodiments, the message may indicate an estimated probability of UE 701 accessing BS 703 (e.g., performing the enhanced CPC). For example, the estimated probability may indicate the probability of UE 701 arriving at BS 703 as “0.8”.

In response to receiving the message, BS 703 would know that UE 701 has accessed PSCell #1C. BS 703 may increase the possibility of UE 701 switching to BS 703. In some embodiments, BS 703 may reserve more resource for UE 701.

It should be appreciated by persons skilled in the art that the sequence of the operations in exemplary procedure 700 may be changed and that some of the operations in exemplary procedure 700 may be eliminated or modified, without departing from the spirit and scope of the disclosure.

FIG. 8 illustrates a flow chart of exemplary procedure 800 for wireless communications in accordance with some embodiments of the present disclosure. Details described in all of the foregoing embodiments of the present disclosure are applicable for the embodiments shown in FIG. 8.

Referring to FIG. 8, in operation 811, UE 801 may be in a connected state (e.g., RRC_CONNECTED state as specified in 3GPP specifications) and may access its serving cells. For example, UE 801 may be connected to two serving BSs, for instance, BS 802A acting as an MN and another BS acting as an SN.

In some embodiments, UE 801 may be configured with a CPC (e.g., PSCell #0D of the SN->PSCell #1D), which may be associated with a target primary cell (e.g., PSCell #1D) of an SCG of BS 802B. In some embodiments, UE 801 may be further configured with an enhanced CPC, which may be associated with a candidate primary cell (e.g., PSCell #2D) of an SCG of BS 803. The enhanced CPC (e.g., PSCell #1D->PSCell #2D) may be performed after the c is performed and an execution condition of the enhanced CPC is met. The descriptions regarding the enhanced CPC in the foregoing embodiments may apply here. For example, the configuration of the enhanced CPC may include a CG configuration based on a reference cell.

In operation 815, UE 801 may evaluate the execution condition of the CPC and may perform a CPC procedure when the execution condition is met. In response to successfully performing the CPC procedure, UE 801 may transmit an RRC reconfiguration complete message to the network (e.g., the source MN BS 802A or the target SN BS 802B). For example, in operation 817, UE 801 may transmit an RRC reconfiguration complete message indicating that UE 801 has performed the CPC to BS 802A.

In response to receiving the RRC reconfiguration complete message, BS 802A may, in operation 819, transmit a message to BS 803 (to which the candidate primary cell of the enhanced CPC belongs). The message may indicate that UE 801 has accesses the target primary cell (e.g., PSCell #1D) of the CPC. In some embodiments, the message may indicate an estimated probability of UE 801 accessing BS 803 (e.g., performing the enhanced CPC). For example, the estimated probability may indicate the probability of UE 801 arriving BS 803 as “0.8”.

In response to receiving the message, BS 803 would know that UE 801 has accessed PSCell #1D. BS 803 may increase the possibility of UE 801 switching to BS 803. In some embodiments, BS 803 may reserve more resource for UE 801.

It should be appreciated by persons skilled in the art that the sequence of the operations in exemplary procedure 800 may be changed and that some of the operations in exemplary procedure 800 may be eliminated or modified, without departing from the spirit and scope of the disclosure.

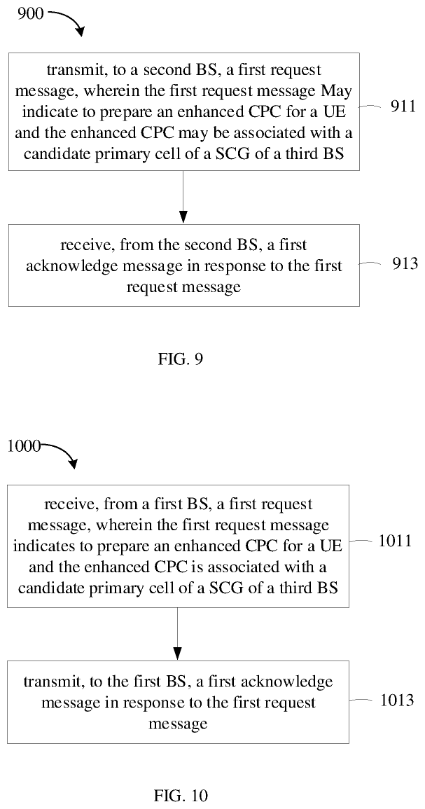

FIG. 9 illustrates a flow chart of exemplary procedure 900 for UE mobility in accordance with some embodiments of the present disclosure. Details described in all of the foregoing embodiments of the present disclosure are applicable for the embodiments shown in FIG. 9. In some examples, the procedure may be performed by a BS.

Referring to FIG. 9, in operation 911, a BS (denoted as “first BS” for clarity) may transmit, to another BS (denoted as “second BS” for clarity), a request message (denoted as “first request message” for clarity). The first request message may indicate to prepare an enhanced CPC for a UE and the enhanced CPC may be associated with a candidate primary cell of an SCG of yet another BS (denoted as “third BS” for clarity). For example, the first BS may be BS 402A in FIG. 4, BS 502A in FIG. 5, BS 602A in FIG. 6, BS 702A in FIG. 7, or BS 802A in FIG. 8.

In some embodiments, the third BS may be the second BS. For example, the second BS and the third BS may be BS 402B in FIG. 4, BS 502B in FIG. 5, BS 602B in FIG. 6, BS 702B in FIG. 7, or BS 802B in FIG. 8. In some embodiments, the third BS may be a BS different from the second BS. For example, the second BS may be BS 402B in FIG. 4, BS 502B in FIG. 5, BS 602B in FIG. 6, BS 702B in FIG. 7, or BS 802B in FIG. 8. For example, the third BS may be BS 403 in FIG. 4, BS 503 in FIG. 5, BS 603 in FIG. 6, BS 703 in FIG. 7, or BS 803 in FIG. 8.

In operation 913, the first BS may receive, from the second BS, an acknowledge message (denoted as “first acknowledge message” for clarity) in response to the first request message.

In some embodiments of the present disclosure, the first request message further indicates at least one of the following: a maximum number of enhanced CPCs configurable by the third BS; a first estimated probability of the UE accessing the second BS; a second estimated probability of the UE switching from the second BS to the third BS; or a third estimated probability of the UE accessing the third BS.

In some embodiments of the present disclosure, the enhanced CPC is performed after a CPA or a CPC for the UE is performed and an execution condition of the enhanced CPC is met, and the CPA or CPC is associated with a target primary cell of an SCG of the second BS. In some embodiments, the first request message is a request message for the CPA or a request message for the CPC. In some embodiments, the first request message is specific for the enhanced CPC.

In some embodiments of the present disclosure, the first BS may receive, from the UE, an RRC reconfiguration complete message indicating that the UE has performed the CPA or CPC. The first BS may transmit a message to the third BS in response to receiving the RRC reconfiguration complete message, wherein the message indicates an estimated probability of the UE accessing the third BS.

In some embodiments of the present disclosure, the first acknowledge message includes at least one configuration of the enhanced CPC for the UE and a configuration of a CPA for the UE. In some embodiments, the first acknowledge message includes the at least one configuration of the enhanced CPC for the UE and a configuration of a CPC for the UE. In some embodiments, the first acknowledge message includes the at least one configuration of the enhanced CPC for the UE. In some embodiments, each of the at least one configuration of the enhanced CPC includes a CG configuration based on a reference cell. In some embodiments, the reference cell is a cell of the second BS.

In some embodiments of the present disclosure, the first BS may transmit, to the UE, an RRC reconfiguration message (denoted as “first RRC reconfiguration message”). The first RRC reconfiguration message may include an indication indicating that the enhanced CPC is contained in the first RRC reconfiguration message. In some embodiments, the first RRC reconfiguration message includes the configuration of the CPA or the configuration of the CPC and a second RRC reconfiguration message including the at least one configuration of the enhanced CPC.

In some other embodiments of the present disclosure, the first BS may transmit, to the UE, an RRC reconfiguration message (denoted as “first RRC reconfiguration message”). In some embodiments, the at least one configuration of the enhanced CPC is included in a conditional reconfiguration IE in the first RRC reconfiguration message. In some embodiments, the at least one configuration of the enhanced CPC is included in an IE specific for enhanced CPC in the first RRC reconfiguration message. In some embodiments, in the case that the at least one configuration of the enhanced CPC is included in the IE specific for enhanced CPC, an enhanced CPC and a CPC are not configured at the same time.

In some embodiments of the present disclosure, the first acknowledge message may include a message rejecting the preparation of the enhanced CPC from the third BS.

It should be appreciated by persons skilled in the art that the sequence of the operations in exemplary procedure 900 may be changed and some of the operations in exemplary procedure 900 may be eliminated or modified, without departing from the spirit and scope of the disclosure.

FIG. 10 illustrates a flow chart of exemplary procedure 1000 for UE mobility in accordance with some embodiments of the present disclosure. Details described in all of the foregoing embodiments of the present disclosure are applicable for the embodiments shown in FIG. 10. In some examples, the procedure may be performed by a BS.

Referring to FIG. 10, in operation 1011, a BS (denoted as “second BS” for clarity) may receive, from another BS (denoted as “first BS” for clarity), a request message (denoted as “first request message” for clarity). The first request message may indicate to prepare an enhanced CPC for a UE and the enhanced CPC may be associated with a candidate primary cell of an SCG of yet another BS (denoted as “third BS” for clarity). For example, the first BS may be BS 402A in FIG. 4, BS 502A in FIG. 5, BS 602A in FIG. 6, BS 702A in FIG. 7, or BS 802A in FIG. 8.

In some embodiments, the third BS may be the second BS. For example, the second BS and the third BS may be BS 402B in FIG. 4. BS 502B in FIG. 5, BS 602B in FIG. 6, BS 702B in FIG. 7, or BS 802B in FIG. 8. In some embodiments, the third BS may be a BS different from the second BS. For example, the second BS may be BS 402B in FIG. 4. BS 502B in FIG. 5, BS 602B in FIG. 6, BS 702B in FIG. 7, or BS 802B in FIG. 8. For example, the third BS may be BS 403 in FIG. 4, BS 503 in FIG. 5, BS 603 in FIG. 6, BS 703 in FIG. 7, or BS 803 in FIG. 8.

In operation 1013, the second BS may transmit, to the first BS, an acknowledge message (denoted as “first acknowledge message” for clarity) in response to the first request message.

In some embodiments of the present disclosure, the enhanced CPC is performed after a CPA or a CPC for the UE is performed and an execution condition of the enhanced CPC is met, and the CPA or CPC is associated with a target primary cell of an SCG of the second BS. In some embodiments, the first request message is a request message for the CPA or CPC. In some embodiments, the first request message is specific for the enhanced CPC.

In some embodiments of the present disclosure, the second BS may transmit a request message (denoted as “second request message” for clarity) to the third BS to indicate to prepare the enhanced CPC. The second BS may receive an acknowledge message (denoted as “second acknowledge message” for clarity) in response to the second request message. The second acknowledge message includes at least one configuration of the enhanced CPC for the UE, wherein each of the at least one configuration of the enhanced CPC includes a CG configuration based on a reference cell. In some embodiments, the first acknowledge message may include the at least one configuration of the enhanced CPC for the UE. In some embodiments, the reference cell is a cell of the second BS.

In some embodiments of the present disclosure, the second BS may transmit a request message (denoted as “second request message” for clarity) to the third BS to indicate to prepare the enhanced CPC. The second BS may receive a message rejecting the preparation of the enhanced CPC from the third BS in response to the second request message. In some embodiments, the first acknowledge message may include the message rejecting the preparation of the enhanced CPC.

In some embodiments of the present disclosure, the first request message and the second request message may indicate at least one of the following: a maximum number of enhanced CPCs configurable by the third BS; a first estimated probability of the UE accessing the second BS; a second estimated probability of the UE switching from the second BS to the third BS; or a third estimated probability of the UE accessing the third BS.

It should be appreciated by persons skilled in the art that the sequence of the operations in exemplary procedure 1000 may be changed and some of the operations in exemplary procedure 1000 may be eliminated or modified, without departing from the spirit and scope of the disclosure.

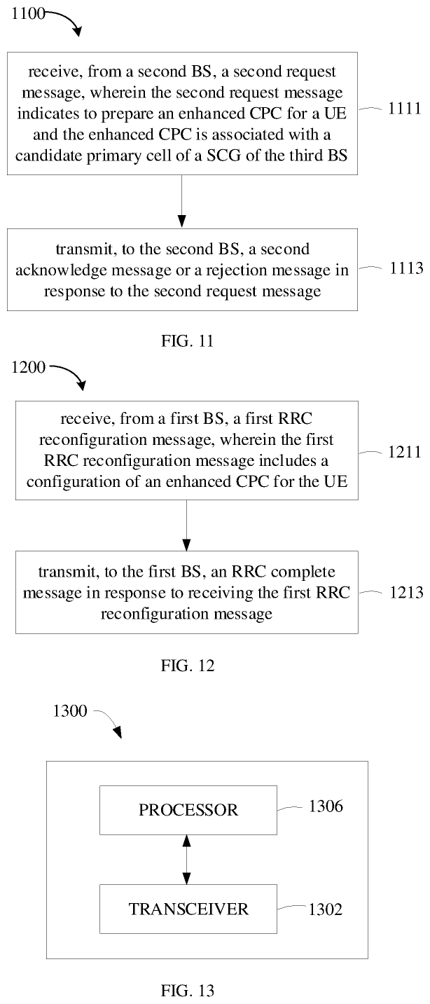

FIG. 11 illustrates a flow chart of exemplary procedure 1100 for UE mobility in accordance with some embodiments of the present disclosure. Details described in all of the foregoing embodiments of the present disclosure are applicable for the embodiments shown in FIG. 11. In some examples, the procedure may be performed by a BS.

Referring to FIG. 11, in operation 1111, a BS (denoted as “third BS” for clarity) may receive, from another BS (denoted as “second BS” for clarity), a request message (denoted as “second request message” for clarity). The second request message may indicate to prepare an enhanced CPC for a UE and the enhanced CPC is associated with a candidate primary cell of a SCG of the third BS. For example, the second BS may be BS 402B in FIG. 4. BS 502B in FIG. 5, BS 602B in FIG. 6, BS 702B in FIG. 7, or BS 802B in FIG. 8. For example, the third BS may be BS 403 in FIG. 4, BS 503 in FIG. 5, BS 603 in FIG. 6, BS 703 in FIG. 7, or BS 803 in FIG. 8.

In operation 1113, the third BS may transmit, to the second BS, an acknowledge message (denoted as “second acknowledge message” for clarity) or a rejection message in response to the second request message.

In some embodiments of the present disclosure, the enhanced CPC is performed after a CPA or a CPC for the UE is performed and an execution condition of the enhanced CPC is met, and the CPA or CPC is associated with a target primary cell of an SCG of the second BS.

In some embodiments of the present disclosure, the second acknowledge message includes at least one configuration of the enhanced CPC for the UE, wherein each of the at least one configuration of the enhanced CPC comprises a CG configuration based on a reference cell. In some embodiments, the reference cell is a cell of the second BS.

In some embodiments of the present disclosure, the second request message indicates at least one of the following: a maximum number of enhanced CPCs configurable by the third BS; a first estimated probability of the UE accessing the second BS; a second estimated probability of the UE switching from the second BS to the third BS; or a third estimated probability of the UE accessing the third BS.

In some embodiments of the present disclosure, the third BS may receive a message indicating an estimated probability of the UE accessing the third BS after the UE has performed the CPA or CPC.

It should be appreciated by persons skilled in the art that the sequence of the operations in exemplary procedure 1100 may be changed and some of the operations in exemplary procedure 1100 may be eliminated or modified, without departing from the spirit and scope of the disclosure.

FIG. 12 illustrates a flow chart of exemplary procedure 1200 for UE mobility in accordance with some embodiments of the present disclosure. Details described in all of the foregoing embodiments of the present disclosure are applicable for the embodiments shown in FIG. 12. In some examples, the procedure may be performed by a UE.

Referring to FIG. 12, in operation 1211, a UE may receive, from a BS (denoted as “first BS” for clarity), an RRC reconfiguration message (denoted as “first RRC reconfiguration message” for clarity). The first RRC reconfiguration message includes a configuration of an enhanced CPC for the UE. In operation 1213, the UE may transmit, to the first BS, an RRC complete message in response to receiving the first RRC reconfiguration message.

For example, the UE may be UE 401 in FIG. 4, UE 501 in FIG. 5, UE 601 in FIG. 6, UE 701 in FIG. 7, or UE 801 in FIG. 8. For example, the first BS may be BS 402A in FIG. 4, BS 502A in FIG. 5, BS 602A in FIG. 6, BS 702A in FIG. 7, or BS 802A in FIG. 8.

In some embodiments of the present disclosure, the first RRC reconfiguration message comprises an indication indicating that the enhanced CPC is contained in the first RRC reconfiguration message and a second RRC reconfiguration message comprising the configuration of the enhanced CPC.

In some embodiments of the present disclosure, the first RRC reconfiguration message comprises a conditional reconfiguration IE for CPA or CPC, which comprises the configuration of the enhanced CPC. In some embodiments of the present disclosure, the first RRC reconfiguration message comprises an IE specific for enhanced CPC, which comprises the configuration of the enhanced CPC.

In some embodiments of the present disclosure, the configuration of the enhanced CPC comprises a CG configuration based on a reference cell.

In some embodiments of the present disclosure, the UE may release the configuration of the enhanced CPC in response to an initiation of a reestablishment procedure or in response to the UE detaching from the first BS.

It should be appreciated by persons skilled in the art that the sequence of the operations in exemplary procedure 1200 may be changed and some of the operations in exemplary procedure 1200 may be eliminated or modified, without departing from the spirit and scope of the disclosure.

FIG. 13 illustrates a block diagram of an exemplary apparatus 1300 according to some embodiments of the present disclosure.

As shown in FIG. 13, the apparatus 1300 may include at least one processor 1306 and at least one transceiver 1302 coupled to the processor 1306. The apparatus 1300 may be a BS or a UE.

Although in this figure, elements such as the at least one transceiver 1302 and processor 1306 are described in the singular, the plural is contemplated unless a limitation to the singular is explicitly stated. In some embodiments of the present application, the transceiver 1302 may be divided into two devices, such as a receiving circuitry and a transmitting circuitry. In some embodiments of the present application, the apparatus 1300 may further include an input device, a memory, and/or other components.

In some embodiments of the present application, the apparatus 1300 may be a UE. The transceiver 1302 and the processor 1306 may interact with each other so as to perform the operations with respect to the UEs described in FIGS. 1-12. In some embodiments of the present application, the apparatus 1300 may be a BS. The transceiver 1302 and the processor 1306 may interact with each other so as to perform the operations with respect to the BSs described in FIGS. 1-12.

In some embodiments of the present application, the apparatus 1300 may further include at least one non-transitory computer-readable medium.

For example, in some embodiments of the present disclosure, the non-transitory computer-readable medium may have stored thereon computer-executable instructions to cause the processor 1306 to implement the method with respect to the UEs as described above. For example, the computer-executable instructions, when executed, cause the processor 1306 interacting with transceiver 1302 to perform the operations with respect to the UEs described in FIGS. 1-12.

In some embodiments of the present disclosure, the non-transitory computer-readable medium may have stored thereon computer-executable instructions to cause the processor 1306 to implement the method with respect to the BSs as described above. For example, the computer-executable instructions, when executed, cause the processor 1306 interacting with transceiver 1302 to perform the operations with respect to the BSs described in FIGS. 1-12.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including.” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A first base station, comprising:
at least one memory; and
at least one processor coupled with the at least one memory and configured to cause the first base station to:
transmit, to a second base station, a first request message, wherein the first request message indicates to prepare an enhanced conditional primary secondary cell (PSCell) change (CPC) for a user equipment (UE) and the enhanced CPC is associated with a candidate primary cell of a secondary cell group (SCG) of a third base station; and
receive, from the second base station, a first acknowledge message in response to the first request message.

2. The first base station of claim 1, wherein the third base station is the second base station or a base station different from the second base station.

3. The first base station of claim 1, wherein the first request message further indicates at least one of the following:
a maximum number of enhanced CPCs configurable by the third base station;
a first estimated probability of the UE accessing the second base station;
a second estimated probability of the UE switching from the second base station to the third base station; or
a third estimated probability of the UE accessing the third base station.

4. The first base station of claim 1, wherein the enhanced CPC is performed after a conditional PSCell addition (CPA) or a CPC for the UE is performed and an execution condition of the enhanced CPC is met, and the CPA or CPC is associated with a target primary cell of an SCG of the second base station; and
wherein the first request message is a request message for the CPA or CPC, or the first request message is specific for the enhanced CPC.

5. The first base station of claim 1, wherein the first acknowledge message comprises:
at least one configuration of the enhanced CPC for the UE and a configuration of a conditional PSCell addition (CPA) for the UE, or
the at least one configuration of the enhanced CPC for the UE and a configuration of a CPC for the UE; or
the at least one configuration of the enhanced CPC for the UE; and
wherein each of the at least one configuration of the enhanced CPC comprises a cell group (CG) configuration based on a reference cell.

6. The first base station of claim 5, wherein the at least one processor is configured to cause the first base station to transmit, to the UE, a first radio resource control (RRC) reconfiguration message, wherein the first RRC reconfiguration message comprises an indication indicating that the enhanced CPC is contained in the first RRC reconfiguration message.

7. The first base station of claim 6, wherein the first RRC reconfiguration message comprises the configuration of the CPA or the configuration of the CPC and a second RRC reconfiguration message comprising the at least one configuration of the enhanced CPC.

8. The first base station of claim 5, wherein the at least one processor is configured to cause the first base station to transmit, to the UE, a first radio resource control (RRC) reconfiguration message; and
wherein the at least one configuration of the enhanced CPC is included in a conditional reconfiguration information element (IE) in the first RRC reconfiguration message, or
wherein the at least one configuration of the enhanced CPC is included in an IE specific for enhanced CPC in the first RRC reconfiguration message.

9. The first base station of claim 8, wherein in the case that the at least one configuration of the enhanced CPC is included in the IE specific for enhanced CPC, an enhanced CPC and a CPC are not configured at the same time.

10. The first base station of claim 5, wherein the reference cell is a cell of the second base station.

11. The first base station of claim 1, wherein the first acknowledge message comprises a message rejecting the preparation of the enhanced CPC from the third base station.

12. The first base station of claim 4, wherein the at least one processor is configured to cause the base station to:
receive, from the UE, a radio resource control (RRC) reconfiguration complete message indicating that the UE has performed the CPA or CPC; and
transmit a message to the third base station in response to receiving the RRC reconfiguration complete message, wherein the message indicates an estimated probability of the UE accessing the third base station.

13. A second base station, comprising:
at least one memory; and
at least one processor coupled with the at least one memory and configured to cause the second base station to:
receive, from a first base station, a first request message, wherein the first request message indicates to prepare an enhanced conditional primary secondary cell (PSCell) change (CPC) for a user equipment (UE) and the enhanced CPC is associated with a candidate primary cell of a secondary cell group (SCG) of a third base station; and
transmit, to the first base station, a first acknowledge message in response to the first request message.

14. The second base station of claim 13, wherein the third base station is the second base station or a base station different from the second base station.

15. A third base station, comprising:
at least one memory; and
at least one processor coupled with the at least one memory and configured to cause the third base station to:
receive, from a second base station, a second request message, wherein the second request message indicates to prepare an enhanced conditional primary secondary cell (PSCell) change (CPC) for a user equipment (UE) and the enhanced CPC is associated with a candidate primary cell of a secondary cell group (SCG) of the third base station; and
transmit, to the second base station, a second acknowledge message or a rejection message in response to the second request message.

16. A user equipment (UE), comprising:
at least one memory; and
at least one processor coupled with the at least one memory and configured to cause the UE to:
receive, from a first base station, a first radio resource control (RRC) reconfiguration message, wherein the first RRC reconfiguration message includes a configuration of an enhanced conditional primary secondary cell (PSCell) change (CPC) for the UE; and
transmit, to the first base station, an RRC complete message in response to receiving the first RRC reconfiguration message.

17. The UE of claim 16, wherein the first RRC reconfiguration message comprises an indication indicating that the enhanced CPC is contained in the first RRC reconfiguration message and a second RRC reconfiguration message comprising the configuration of the enhanced CPC.

18. The UE of claim 16, wherein the first RRC reconfiguration message comprises a conditional reconfiguration information element (IE) for CPA or CPC, which comprises the configuration of the enhanced CPC; or
wherein the first RRC reconfiguration message comprises an IE specific for enhanced CPC, which comprises the configuration of the enhanced CPC.

19. The UE of claim 16, wherein the configuration of the enhanced CPC comprises a cell group (CG) configuration based on a reference cell.

20. The UE of claim 16, wherein the at least one processor is configured to cause the UE to release the configuration of the enhanced CPC in response to an initiation of a reestablishment procedure or in response to the UE detaching from the first base station.
